(19) United States
(12) Patent Application Publication
(10) Pub. No.: US 2024/0212376 A1
(43) Pub. Date: Jun. 27, 2024

(54) OCR BASED ON ML TEXT SEGMENTATION INPUT

(71) Applicant: Raytheon Company, Waltham, MA (US)

(72) Inventors: Philip A. Sallee, South Riding, VA (US); Jack Anthony Mucciaccio, Omaha, NE (US)

(21) Appl. No.: 18/086,238

(22) Filed: Dec. 21, 2022

(51) Int. Cl. G06V 30/148

(52) U.S. Cl. CPC G06V 30/153; G06V 2201/10

(57) ABSTRACT

Embodiments regard improving Optical Character Recognition (OCR) performance. A method includes providing an image including text as input to a text segmentation model, receiving, from the text segmentation model, a per-pixel segmentation map of the image, providing the per-pixel segmentation map as input to an OCR engine, and receiving, as output from the OCR engine based on the per-pixel segmentation map, a digitized version of the image.

### TECHNICAL FIELD

Embodiments provide improved optical character recognition (OCR). In lieu of using a given file as input, an output of a machine learning (ML) text segmentation model generated based on the given file is used as input to an OCR model. The text segmentation model can further provide metadata regarding text of the given file that can help further improve OCR performance.

### BACKGROUND

Optical Character Recognition (OCR) from scanned documents is often challenged by poor image quality due to scan noise, damage to physical documents, and presence of graphics, tables, or other items that confuse OCR techniques. Scanning processes reduce or increase pixel contrast, and obscure text features. Most pre-processing approaches for OCR involve applying transformations directly to the image pixels themselves and then using the transformed image as input to the OCR.

### BRIEF DESCRIPTION OF THE DRAWINGS

FIG. 1 illustrates, by way of example, portions of files that include a variety of blemishes that confuse ML-based OCR techniques.

FIG. 2 illustrates, by way of example, a diagram of an embodiment of a system for improved OCR.

FIG. 3 illustrates, by way of example, a diagram of an image and a corresponding per-pixel image classification map.

FIG. 4 illustrates an example of an image.

FIG. 5 illustrates, by way of example, output of the OCR engine when the image of FIG. 4 is used as the input (without any pre-processing).

FIG. 6 illustrates an example of a per-pixel image classification map generated by the text segmentation model with the image of FIG. 4 as input.

FIG. 7 illustrates output of the OCR engine when the per-pixel classification map of FIG. 6 is used as the input (without any other pre-processing).

FIG. 8 illustrates, by way of example, a diagram of an embodiment of a method for improved OCR.

FIG. 9 is a block diagram of an example of an environment including a system for neural network training.

FIG. 10 illustrates, by way of example, a block diagram of an embodiment of a machine in the example form of a computer system within which instructions, for causing the machine to perform any one or more of the methods discussed herein, may be executed.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Scanning processes tend to bleed out the dark text, filling holes and other features that obscure textual features. In embodiment, a machine learning (ML) model (e.g., U-Net segmentation model or other segmentation model) is trained to classify each pixel of an image as text or non-text. Using the segmentation model, text annotations label only the inner skeleton of the text while darker pixels around the central text skeleton (such as bleed out) are not labeled as text. For labeling documents and training the ML model, an interactive labeling tool can be leveraged to help indicate what text is desired. For example, text that is part of a graphic may or may not be desired in the output. In using the interactive labeling tool, one can teach the ML Model which text is desired. Pixel-wise classification output from the trained ML model is then fed into an OCR tool, such as Tesseract or other OCR tool, in place of image pixels. Embodiments provide a pre-processing step that improves accuracy of automatic OCR text extraction from scanned documents.

Text is a piece of writing in a language. Text includes alphanumeric characters, accents, and punctuation.

As discussed in the Background, most pre-processing approaches for OCR apply transformations to the image pixels themselves. Embodiments, in contrast, use the direct output of an ML pixel-wise segmentation model as input to an OCR engine. Most ML models for document segmentation identify regions of the document images and classify according to general content type. In embodiments, the labeling is done in such a way that the output identifies the actual skeletal structure of the characters, rather than general text regions.

Existing OCR methods include ML-based open-source OCR tools, such as Tesseract. However, Tesseract alone does not always correctly identify which regions of an image are text. Further, Tesseract, and other OCR methods, have difficulty differentiating text pixels from non-text pixels due to varying color (e.g., gray or other color) levels and image quality. Standard approaches described in documentation and literature include image preprocessing, for example dilation filters and contrast normalization approaches. While dilation improves recognition of some characters, dilation causes lighter characters to be lost, and also fails to restore holes that have been filled in due to bleed caused by one or more scans or re-scans. Embodiments use an ML text segmentation model to reconstruct binary-valued characters for consistent input into an OCR tool, with demonstrable improvement over standard preprocessing methods.

Text segmentation is a process of dividing written text into meaningful units, such as words, sentences, or topics. In embodiments, text segmentation means per-pixel text segmentation. The problem is non-trivial, because while some written languages have explicit word boundary markers, such as the word spaces of written English and the distinctive initial, medial and final letter shapes of Arabic, such signals are sometimes ambiguous and not present in all written languages. Automatic segmentation is the problem in natural language processing (NLP) of implementing a computer process to segment text. When punctuation and similar clues are not consistently available, the segmentation task often requires fairly non-trivial techniques, such as statistical decision-making, large dictionaries, as well as consideration of syntactic and semantic constraints. Effective natural language processing systems and text segmentation tools usually operate on text in specific domains and sources. As an example, processing text used in medical records is a very different problem than processing news articles or real estate advertisements. As per most ML techniques, the process of developing text segmentation tools starts with collecting a large corpus of text in an application domain.

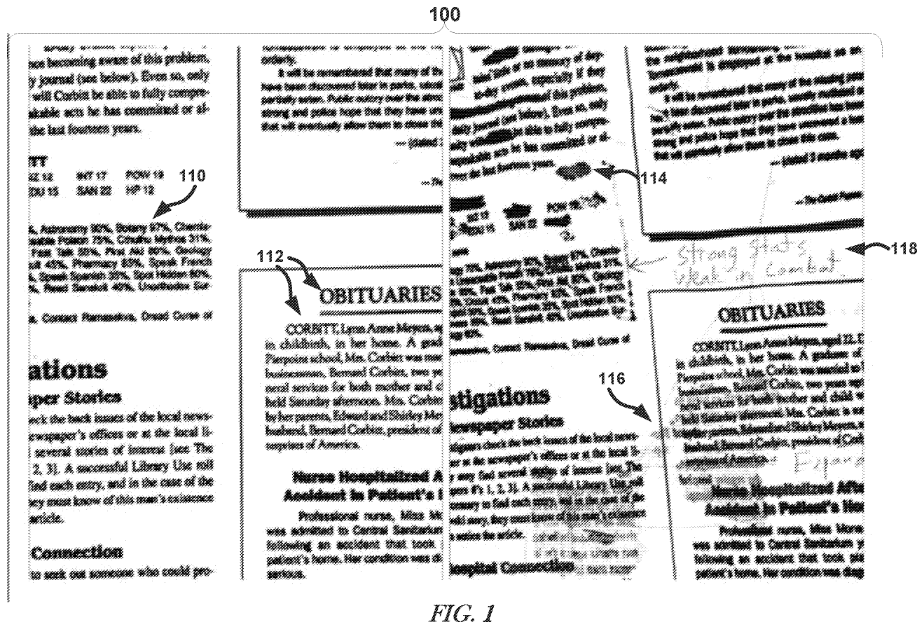

FIG. 1 illustrates, by way of example, portions of files 100 that include a variety of blemishes that confuse ML-based OCR techniques. The blemishes in FIG. 1 are just examples and more blemish types exist. The example blemishes in FIG. 1 include blurring (indicated by arrow 110), different font sizes, styles, or types (indicated by arrow 112), smudges or other background discoloration (indicated by arrow 114), ghost text (indicated by arrow 116), and manual annotations (indicated by arrow 118). ML-based OCR struggles to properly recognize text in an image that suffers from any of these blemishes. Photocopied, scanning, manually annotating, or the like causes text characters to either lighten or darken and bleed into holes between characters. Scanning or copying can introduce additional noise artifacts that confuse OCR, such as the background discoloration. Diagrams, lines, tables, highlights, paper texture, handwriting, etc. can cause additional OCR errors.

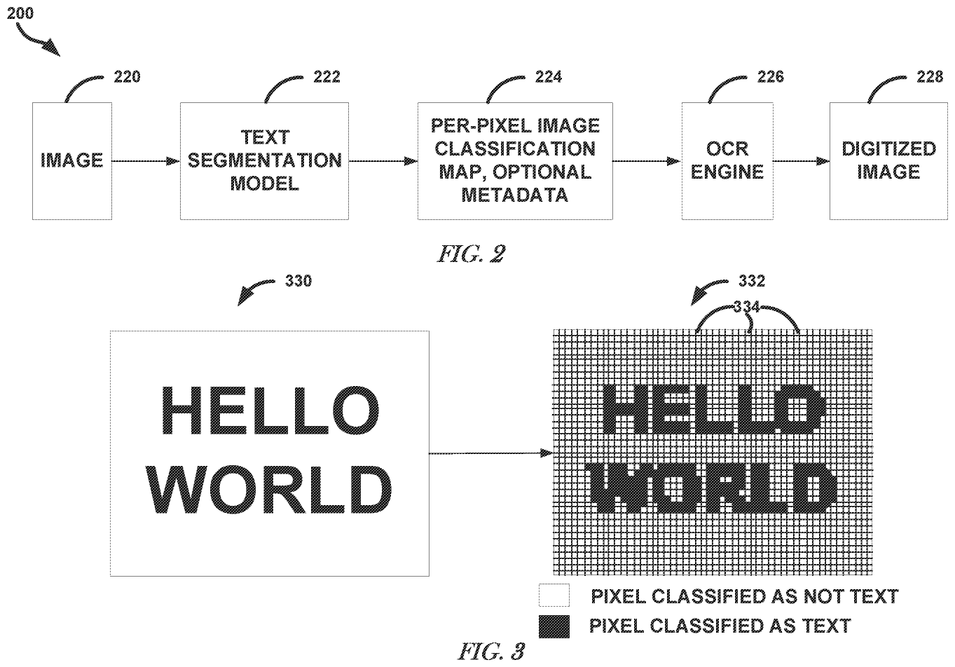

FIG. 2 illustrates, by way of example, a diagram of an embodiment of a system 200 for improved OCR. The system 200 as illustrated includes an image 220 input into a text segmentation model 222. The text segmentation model 222 produces a per-pixel image classification map 224 based on the image 220. The per-pixel image classification map 224 is provided to an OCR engine 226 as input. The OCR engine 226 produces a digitized version of the text characters in the image 220 based on the per-pixel image classification map 224.

The image 220 includes text therein. The image can be of a file, another image, a poster, or other object that includes text. The image 220 can be generated by a camera, photocopier, scanner, or the like. The image 220 can have a resolution that is coarser or finer.

The text segmentation model 222 receives the image 220 and produces the per-pixel image classification map 224. The text segmentation model 222 is an ML model. The text segmentation model 222 is trained in a supervised manner. An example text segmentation model is U-Net generated by the computer science department at the University of Freiburg in Germany. The text segmentation model 222 determines, for each pixel in the input image 220, whether the pixel includes text or does not include text. For each pixel in the image 220 that is determined to be part of text, the text segmentation model 222 sets a corresponding pixel in the per-pixel image classification map 224 to a first specified value. For each pixel in the image 220 that is determined to not be a part of text, the text segmentation model 222 sets a corresponding pixel in the per-pixel image classification map 224 to a second, different specified value. The values can include extreme white (e.g., min value) and extreme black (e.g., max value). This allows the text segmentation model 222 to remove blemishes from the image 220 that are otherwise troublesome for the OCR engine 226.

FIG. 3 illustrates, by way of example, a diagram of an image 330 and a corresponding per-pixel image classification map 332. The image 330 includes text “HELLO WORLD”. The image 330 is an example of the image 220. The image 330 can be provided to the text segmentation model 222. The text segmentation model 222 produces the corresponding per-pixel image classification map 332. The image classification map 332 is itself an image, but with each pixel 334 set to one of only two possible values. One of the two possible values indicates that the pixel 334 is a part of text and the other of the two possible values indicates that the pixel 334 is not a part of text. This example in FIG. 3 is quite granular (52×52 pixels), and more pixels are much more typical.

The text segmentation model 222 can provide metadata to the OCR engine 226. The metadata can indicate a font type, font size, language, or the like of the text. The metadata can help the OCR engine 226 recognize a character in the text by further indicating a finer structure of the underlying text. The font size can help the OCR engine 226 understand about how many pixels vertically and horizontally can correspond to a given character. The language can further reduce the OCR engine 226 search for a given character structure.

The OCR engine 226 receives the per-pixel image classification map 224 and optionally the metadata from the text segmentation model 222. The OCR engine 226 produces a digitized, searchable image 228. The image 228 is a version of the image 220 that is generated based on the per-pixel image classification map 224 and optionally the metadata. There are many OCR engines generally available, Tesseract is an example of the OCR engine 226.

OCR is the conversion of images of typed, handwritten, or printed text into machine-encoded text, whether from a scanned document, a photo of a document, a scene-photo (for example the text on signs and billboards in a landscape photo) or from subtitle text superimposed on an image (for example from a television broadcast). Widely used as a form of data entry from printed paper data records—whether passport documents, invoices, bank statements, computerized receipts, business cards, mail, printouts of static-data, or any suitable documentation—it is a common method of digitizing printed texts so that they can be electronically edited, searched, stored more compactly, displayed on-line, used in machine processes such as cognitive computing, machine translation, text-to-speech, key data, text mining, or a combination thereof. OCR is a field of research in pattern recognition, artificial intelligence, and computer vision.

Early versions of OCR needed to be trained with images of each character and worked on one font at a time. Advanced systems capable of producing a high degree of recognition accuracy for most fonts are now common, and with support for a variety of digital image file format inputs. Some systems are capable of reproducing formatted output that closely approximates the original page including images, columns, and other non-textual components.

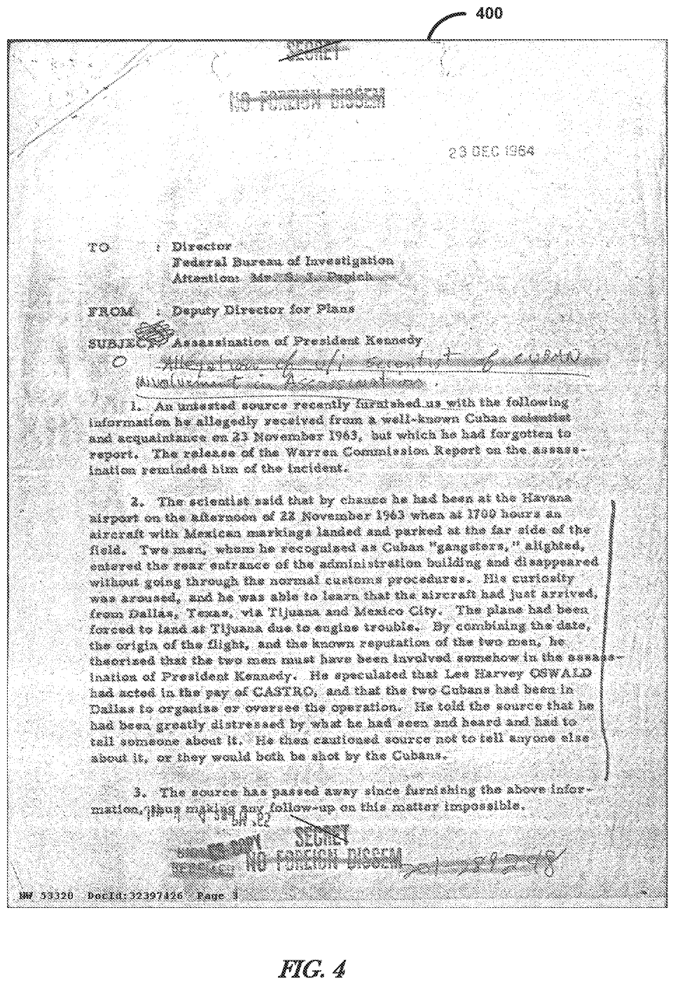

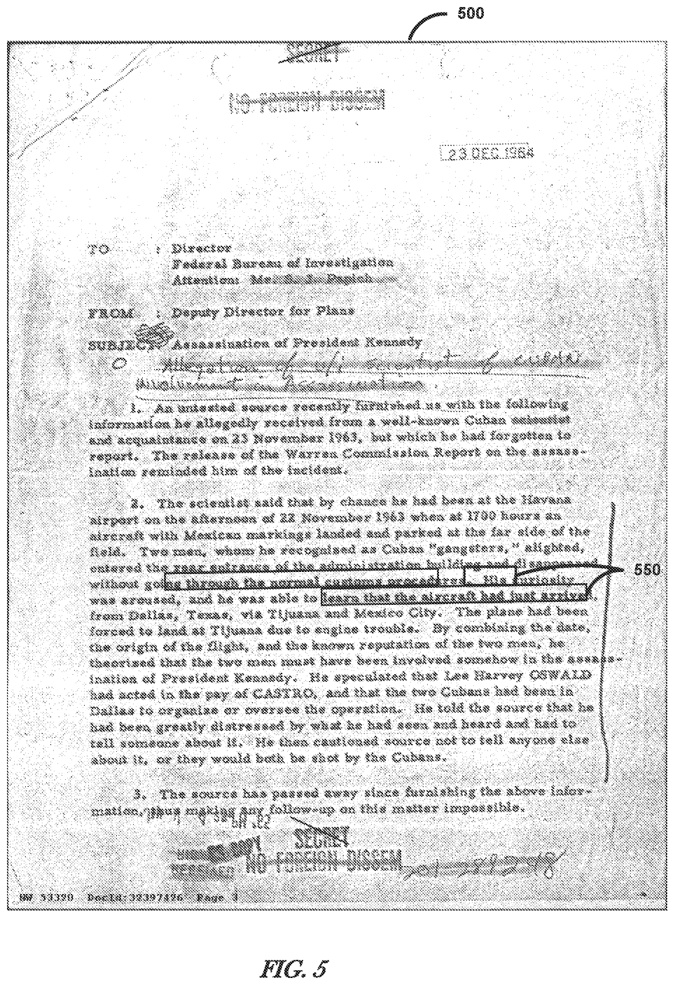

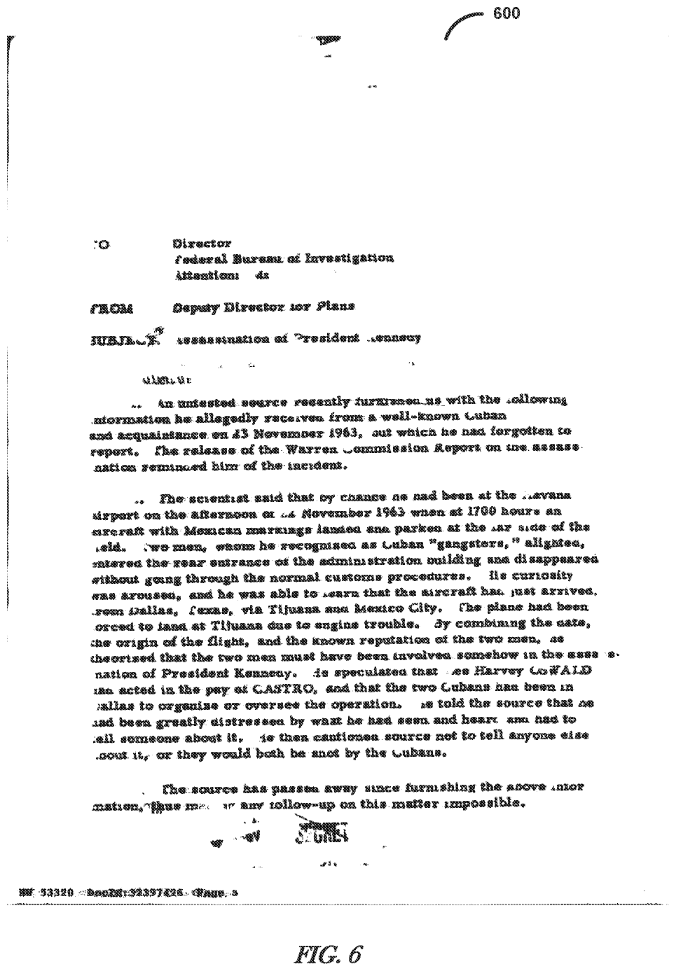

FIGS. 4, 5, 6, and 7 illustrate improvements provided by embodiments while highlighting drawbacks of prior OCR pre-processing techniques. FIG. 4 illustrates an example of an image 400. The image 400 is an example of the image 220. FIG. 5 illustrates output of the OCR engine 226 when the image 400 is used as the input (without any pre-processing). Bounding boxes 550 indicate which portions of the image 500 include recognizable text after the OCR engine 226 performs its operations. As can be seen, very little of the text of the image 500 is recognized as text by the OCR engine 226 with the image 400 as input.

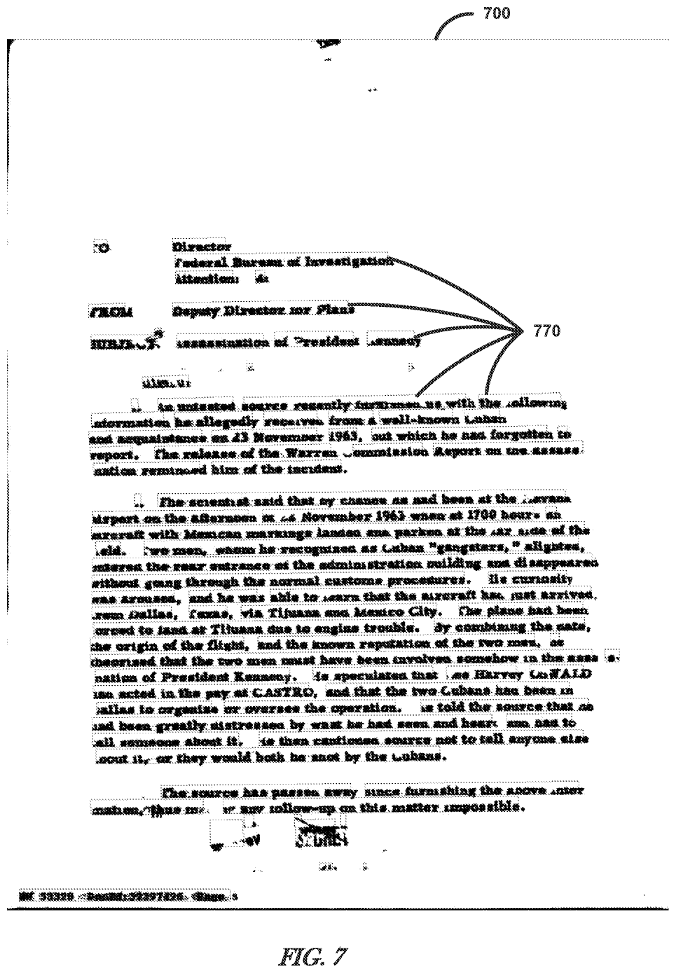

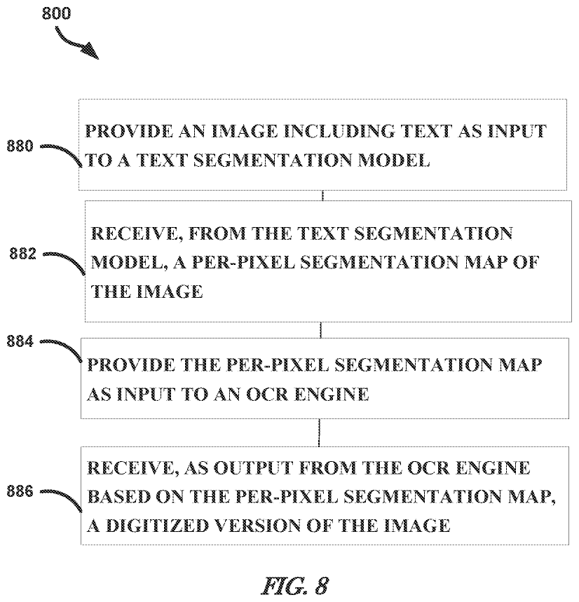

FIG. 6 illustrates an example of a per-pixel image classification map 600 generated by the text segmentation model 222 with the image 400 as input. The per-pixel image classification map 600 converts each pixel of the image 400 to one of two specified colors (black and white in the example of FIG. 6). FIG. 7 illustrates output of the OCR engine 226 when the per-pixel classification map 600 is used as the input (without any other pre-processing). Bounding boxes 770 indicate which portions of the image 700 include recognizable text after the OCR engine 226 performs its operations. As can be seen, a large majority of the text of the image 700 is recognized as text by the OCR engine 226 with the per-pixel classification map 600 as input. The operation of the OCR engine 226 is thus vastly improved using the output of the text segmentation model as a pre-processing operation for OCR.

FIG. 8 illustrates, by way of example, a diagram of an embodiment of a method 800 for improved OCR. The method 800 as illustrated includes providing an image including text as input to a text segmentation model, at operation 880; receiving, from the text segmentation model, a per-pixel segmentation map of the image, at operation 882; providing the per-pixel segmentation map as input to an OCR engine, at operation 884; and receiving, as output from the OCR engine based on the per-pixel segmentation map, a digitized version of the image, at operation 886.

The method 800 can further include, wherein the per-pixel segmentation map includes one of only two values, a first value and a second, different value for each pixel of the image. The method 800 can further include, wherein the first value indicates the pixel is part of a character in the image and the second value indicates the pixel is not part of a character in the image.

The method 800 can further include, wherein the first value corresponds to a dark color and the second value corresponds to a light color. A light color is a color with a corresponding value that is within a range [⅔ max value, max value]. A dark color is a color with corresponding value that is within a range [min value, ⅓ max value]. For example, in a grayscale color scheme with color value ranges [0, 255], a dark value can be any color value in the range [0, 85] and a light color can be any color value in the range [170, 255].

The method 800 can further include further receiving, from the text segmentation model based on the image, metadata regarding characters in the text in the image. The method 800 can further include providing the metadata as further input to the OCR engine along with the per-pixel segmentation map. The method 800 can further include, wherein the metadata indicates a font type of one or more characters of the characters in the text. The method 800 can further include, wherein the metadata indicates a language of the text in the image.

Artificial Intelligence (AI) is a field concerned with developing decision-making systems to perform cognitive tasks that have traditionally required a living actor, such as a person. Neural networks (NNs) are computational structures that are loosely modeled on biological neurons. Generally, NNs encode information (e.g., data or decision making) via weighted connections (e.g., synapses) between nodes (e.g., neurons). Modern NNs are foundational to many AI applications, such as object recognition, device behavior modeling (as in the present application) or the like. The text segmentation model 222, OCR engine 226, or other component or operation can include or be implemented using one or more NNs.

Many NNs are represented as matrices of weights (sometimes called parameters) that correspond to the modeled connections. NNs operate by accepting data into a set of input neurons that often have many outgoing connections to other neurons. At each traversal between neurons, the corresponding weight modifies the input and is tested against a threshold at the destination neuron. If the weighted value exceeds the threshold, the value is again weighted, or transformed through a nonlinear function, and transmitted to another neuron further down the NN graph—if the threshold is not exceeded then, generally, the value is not transmitted to a down-graph neuron and the synaptic connection remains inactive. The process of weighting and testing continues until an output neuron is reached; the pattern and values of the output neurons constituting the result of the NN processing.

The optimal operation of most NNs relies on accurate weights. However, NN designers do not generally know which weights will work for a given application. NN designers typically choose a number of neuron layers or specific connections between layers including circular connections. A training process may be used to determine appropriate weights by selecting initial weights.

In some examples, initial weights may be randomly selected. Training data is fed into the NN, and results are compared to an objective function that provides an indication of error. The error indication is a measure of how wrong the NN's result is compared to an expected result. This error is then used to correct the weights. Over many iterations, the weights will collectively converge to encode the operational data into the NN. This process may be called an optimization of the objective function (e.g., a cost or loss function), whereby the cost or loss is minimized.

A gradient descent technique is often used to perform objective function optimization. A gradient (e.g., partial derivative) is computed with respect to layer parameters (e.g., aspects of the weight) to provide a direction, and possibly a degree, of correction, but does not result in a single correction to set the weight to a “correct” value. That is, via several iterations, the weight will move towards the “correct,” or operationally useful, value. In some implementations, the amount, or step size, of movement is fixed (e.g., the same from iteration to iteration). Small step sizes tend to take a long time to converge, whereas large step sizes may oscillate around the correct value or exhibit other undesirable behavior. Variable step sizes may be attempted to provide faster convergence without the downsides of large step sizes.

Backpropagation is a technique whereby training data is fed forward through the NN—here “forward” means that the data starts at the input neurons and follows the directed graph of neuron connections until the output neurons are reached—and the objective function is applied backwards through the NN to correct the synapse weights. At each step in the backpropagation process, the result of the previous step is used to correct a weight. Thus, the result of the output neuron correction is applied to a neuron that connects to the output neuron, and so forth until the input neurons are reached. Backpropagation has become a popular technique to train a variety of NNs. Any well-known optimization algorithm for back propagation may be used, such as stochastic gradient descent (SGD), Adam, etc.

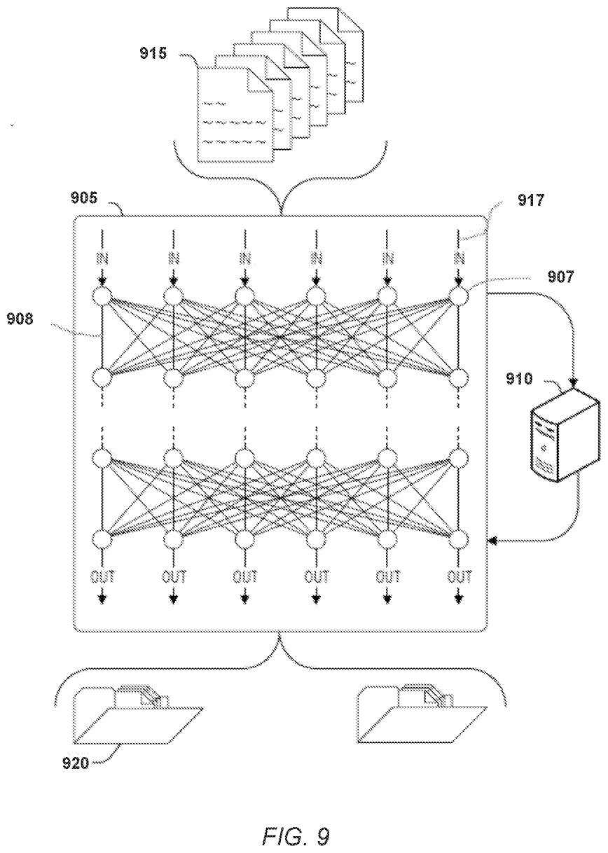

FIG. 9 is a block diagram of an example of an environment including a system for neural network training. The system includes an artificial NN (ANN) 905 that is trained using a processing node 910. The processing node 910 may be a central processing unit (CPU), graphics processing unit (GPU), field programmable gate array (FPGA), digital signal processor (DSP), application specific integrated circuit (ASIC), or other processing circuitry. In an example, multiple processing nodes may be employed to train different layers of the ANN 905, or even different nodes 907 within layers. Thus, a set of processing nodes 910 is arranged to perform the training of the ANN 905.

The set of processing nodes 910 is arranged to receive a training set 915 for the ANN 905. The ANN 905 comprises a set of nodes 907 arranged in layers (illustrated as rows of nodes 907) and a set of inter-node weights 908 (e.g., parameters) between nodes in the set of nodes. In an example, the training set 915 is a subset of a complete training set. Here, the subset may enable processing nodes with limited storage resources to participate in training the ANN 905.

The training data may include multiple numerical values representative of a domain, such as an image feature, or the like. Each value of the training or input 917 to be classified after ANN 905 is trained, is provided to a corresponding node 907 in the first layer or input layer of ANN 905. The values propagate through the layers and are changed by the objective function.

As noted, the set of processing nodes is arranged to train the neural network to create a trained neural network. After the ANN is trained, data input into the ANN will produce valid classifications 920 (e.g., the input data 917 will be assigned into categories), for example. The training performed by the set of processing nodes 907 is iterative. In an example, each iteration of the training the ANN 905 is performed independently between layers of the ANN 905. Thus, two distinct layers may be processed in parallel by different members of the set of processing nodes. In an example, different layers of the ANN 905 are trained on different hardware. The members of different members of the set of processing nodes may be located in different packages, housings, computers, cloud-based resources, etc. In an example, each iteration of the training is performed independently between nodes in the set of nodes. This example is an additional parallelization whereby individual nodes 907 (e.g., neurons) are trained independently. In an example, the nodes are trained on different hardware.

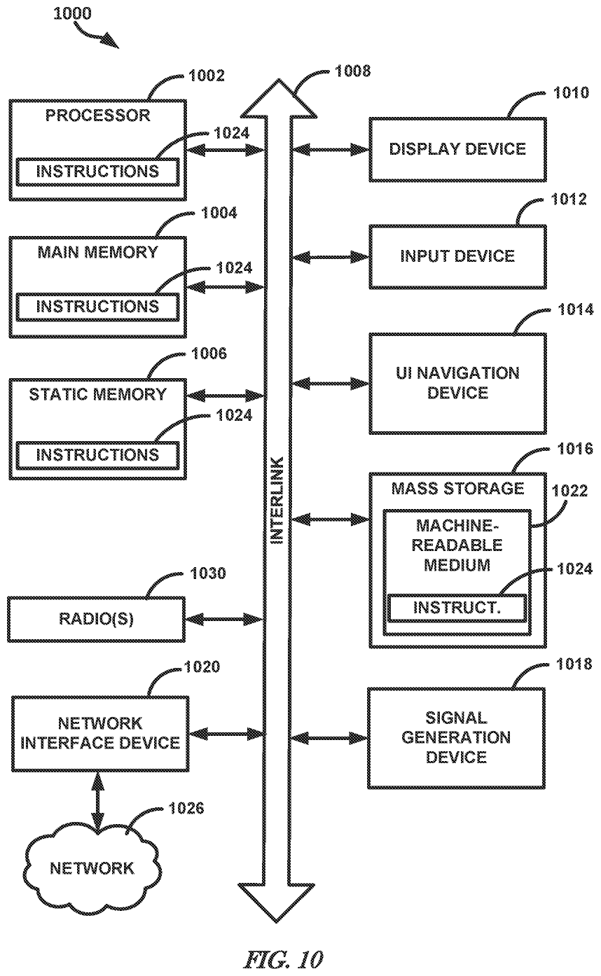

FIG. 10 illustrates, by way of example, a block diagram of an embodiment of a machine in the example form of a computer system 1000 within which instructions, for causing the machine to perform any one or more of the methods discussed herein, may be executed. One or more of the text segmentation model 222, OCR engine 226, method 800, or other device, component, operation, or method discussed can include, or be implemented or performed by one or more of the components of the computer system 1000. In a networked deployment, the machine may operate in the capacity of a server or a client machine in server-client network environment, or as a peer machine in a peer-to-peer (or distributed) network environment. The machine may be a personal computer (PC), server, a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a user interface (UI) navigation device 1014 (e.g., a mouse), a mass storage unit 1016, a signal generation device 1018 (e.g., a speaker), a network interface device 1020, and a radio 1030 such as Bluetooth, WWAN, WLAN, and NFC, permitting the application of security controls on such protocols.

The mass storage unit 1016 includes a machine-readable medium 1022 on which is stored one or more sets of instructions and data structures (e.g., software) 1024 embodying or utilized by any one or more of the methodologies or functions described herein. The instructions 1024 may also reside, completely or at least partially, within the main memory 1004 and/or within the processor 1002 during execution thereof by the computer system 1000, the main memory 1004 and the processor 1002 also constituting machine-readable media.

While the machine-readable medium 1022 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding, or carrying instructions for execution by the machine and that cause the machine to perform any one or more of the methodologies of the present invention, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 1024 may further be transmitted or received over a communications network 1026 using a transmission medium. The instructions 1024 may be transmitted using the network interface device 1020 and any one of a number of well-known transfer protocols (e.g., HTTPS). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible media to facilitate communication of such software.

### ADDITIONAL NOTES AND EXAMPLES

Example 1 includes a method for optical character recognition (OCR) comprising providing an image including text as input to a text segmentation model, receiving, from the text segmentation model, a per-pixel segmentation map of the image, providing the per-pixel segmentation map as input to an OCR engine, and receiving, as output from the OCR engine based on the per-pixel segmentation map, a digitized version of the image.

In Example 2, Example 1 further includes, wherein the per-pixel segmentation map includes one of only two values, a first value and a second, different value for each pixel of the image.

In Example 3, Example 2 further includes, wherein the first value indicates the pixel is part of a character in the image and the second value indicates the pixel is not part of a character in the image.

In Example 4, Example 3 further includes, wherein the first value corresponds to a dark color and the second value corresponds to a light color.

In Example 5, at least one of Examples 1-4 further includes further receiving, from the text segmentation model based on the image, metadata regarding characters in the text in the image, and providing the metadata as further input to the OCR engine along with the per-pixel segmentation map.

In Example 6, Example 5 further includes, wherein the metadata indicates a font type of one or more characters of the characters in the text.

In Example 7, at least one of Examples 5-6 further includes, wherein the metadata indicates a language of the text in the image.

Example 8 includes a non-transitory machine-readable medium including instructions that, when executed by a machine, cause the machine to perform operations for OCR recognition, the operations comprising the method of one of Examples 1-7.

Example 9 includes a system for OCR recognition, the system comprising processing circuitry, a memory including instructions that, when executed by the processing circuitry, cause the processing circuitry to perform operations comprising the method of one of Examples 1-7.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instance or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method for optical character recognition (OCR) comprising:
providing an image including text as input to a text segmentation model;
receiving, from the text segmentation model, a per-pixel segmentation map of the image;
providing the per-pixel segmentation map as input to an OCR engine; and
receiving, as output from the OCR engine based on the per-pixel segmentation map, a digitized version of the image.

2. The method of claim 1, wherein the per-pixel segmentation map includes one of only two values, a first value and a second, different value for each pixel of the image.

3. The method of claim 2, wherein the first value indicates the pixel is part of a character in the image and the second value indicates the pixel is not part of a character in the image.

4. The method of claim 3, wherein the first value corresponds to a dark color and the second value corresponds to a light color.

5. The method of claim 1, further comprising:
further receiving, from the text segmentation model based on the image, metadata regarding characters in the text in the image; and
providing the metadata as further input to the OCR engine along with the per-pixel segmentation map.

6. The method of claim 5, wherein the metadata indicates a font type of one or more characters of the characters in the text.

7. The method of claim 5, wherein the metadata indicates a language of the text in the image.

8. A non-transitory machine-readable medium including instructions that, when executed by a machine, cause the machine to perform operations for optical character recognition (OCR), the operations comprising:
providing an image including text as input to a text segmentation model;
receiving, from the text segmentation model, a per-pixel segmentation map of the image;
providing the per-pixel segmentation map as input to an OCR engine; and
receiving, as output from the OCR engine based on the per-pixel segmentation map, a digitized version of the image.

9. The non-transitory machine-readable medium of claim 8, wherein the per-pixel segmentation map includes one of only two values, a first value and a second, different value for each pixel of the image.

10. The non-transitory machine-readable medium of claim 9, wherein the first value indicates the pixel is part of a character in the image and the second value indicates the pixel is not part of a character in the image.

11. The non-transitory machine-readable medium of claim 10, wherein the first value corresponds to a dark color and the second value corresponds to a light color.

12. The non-transitory machine-readable medium of claim 8, wherein the operations further comprise:
further receiving, from the text segmentation model based on the image, metadata regarding characters in the text in the image; and
providing the metadata as further input to the OCR engine along with the per-pixel segmentation map.

13. The non-transitory machine-readable medium of claim 12, wherein the metadata indicates a font type of one or more characters of the characters in the text.

14. The non-transitory machine-readable medium of claim 12, wherein the metadata indicates a language of the text in the image.

15. A system for optical character recognition (OCR), the system comprising:
processing circuitry;
a memory including instructions that, when executed by the processing circuitry, cause the processing circuitry to perform operations comprising:
providing an image including text as input to a text segmentation model;
receiving, from the text segmentation model, a per-pixel segmentation map of the image;
providing the per-pixel segmentation map as input to an OCR engine; and
receiving, as output from the OCR engine based on the per-pixel segmentation map, a digitized version of the image.

16. The system of claim 15, wherein the per-pixel segmentation map includes one of only two values, a first value and a second, different value for each pixel of the image.

17. The system of claim 16, wherein the first value indicates the pixel is part of a character in the image and the second value indicates the pixel is not part of a character in the image.

18. The system of claim 17, wherein the first value corresponds to a dark color and the second value corresponds to a light color.

19. The system of claim 15, wherein the operations further comprise:
further receiving, from the text segmentation model based on the image, metadata regarding characters in the text in the image; and
providing the metadata as further input to the OCR engine along with the per-pixel segmentation map.

20. The system of claim 19, wherein the metadata indicates a font type of one or more characters of the characters in the text, a language of the text in the image, or a combination thereof.
